(19) United States
(12) Patent Application Publication
(10) Pub. No.: US 2010/0239214 A1
(43) Pub. Date: Sep. 23, 2010

(54) APPARATUS AND ARRANGEMENT FOR TRIMMING AND SPLICING OF OPTICAL WAVEGUIDES

(76) Inventors: Rainer M. Kossat, Aschau (DE); Joachim Wichner, Munchen (DE)

Correspondence Address: CORNING INCORPORATED, INTELLECTUAL PROPERTY DEPARTMENT, SP-TI-3-1, CORNING, NY, 14831, US

(21) Appl. No.: 12/725,619

(22) Filed: Mar. 17, 2010

(30) Foreign Application Priority Data
Mar. 20, 2009 (DE) 202009003964.1

(51) Int. Cl. G02B 6/255

(52) U.S. Cl. 385/96

(57) ABSTRACT

An apparatus for trimming and splicing of optical waveguides is disclosed. One embodiment of the apparatus includes a holding device for holding one of the optical waveguides, a trimming device for trimming of one of the optical waveguides and a control device for controlling a movement of at least one of the holding device and the trimming device. The control device drives at least one of the holding device and the trimming device such that the at least one of the holding device and the trimming device is moved to a first position at which one of the optical waveguides can be trimmed by means of the trimming device.

### RELATED APPLICATIONS

This application claims the benefit of German Application No. 202009003964.1, filed Mar. 20, 2009, the entire contents of which are hereby incorporated by reference.

### BACKGROUND

The disclosure relates to an apparatus for trimming and splicing of optical waveguides. The disclosure furthermore relates to an apparatus for trimming and splicing of optical waveguides.

In order to splice optical waveguides, the ends of the optical waveguides to be connected are first of all heated. Once the material of the optical waveguides starts to melt at the ends, the end surfaces of the optical waveguides are brought into contact, and are welded to one another. Before the optical waveguides are spliced to one another, the optical waveguides are prepared. First of all, the coating which is arranged around the light-carrying core of an optical waveguide is stripped off. Since dirt on the end surfaces of the optical waveguides results in high attenuation when light is transmitted via a splice point, the end surfaces must be cleaned before the splicing process. A further reason for high attenuation at a splice point is splitting on the end surfaces of the optical waveguides. It is therefore necessary for the end surfaces of the optical waveguides to be spliced to be cut by a trimming appliance before the splicing process.

Once the preparation of the optical waveguides has been completed, the optical waveguides are in each case fixed in a holding device of a splicing apparatus. They are fixed in such a manner that a section of an optical waveguide from which the coating has been pulled off the fibre core projects out of the holding device. In order to heat the ends of the optical waveguides, they are moved to a position close to a heating device. The movement of the holding devices is in this case dependent on the length of the end sections of the optical waveguides projecting out of the holding devices.

It is desirable to specify an apparatus and an arrangement for trimming and splicing of optical waveguides, in which it is possible for a respective end of the optical waveguides to project by a defined length out of a holding device after trimming, in order that the holding device can be moved as quickly as possible to a position for heating the respective ends of the optical waveguides.

### SUMMARY

According to one embodiment an apparatus for trimming and splicing of optical waveguides comprises a holding device for holding one of the optical waveguides, a trimming device for trimming of one of the optical waveguides and a control device for controlling a movement of at least one of the holding device and the trimming device and for controlling the trimming of one of the optical waveguides. The control device drives at least one of the holding device and the trimming device such that the at least one of the holding device and the trimming device is moved to a first position at which one of the optical waveguides can be trimmed by means of the trimming device.

According to a further embodiment, the control device drives the trimming device in order to trim one of the optical waveguides.

According to a further embodiment of the apparatus for trimming and splicing of the optical waveguides, the holding device is designed such that the one of the optical waveguides can be fixed to the holding device in that a first section of one of the optical waveguides is held on the holding device and a second section, which is adjacent to the first section, projects out of the holding device. The trimming device is designed to trim one of the optical waveguides at a point on the second section, while one of the optical waveguides is fixed in the holding device. The trimming device can also be designed to trim one of the optical waveguides at the point such that the second section of one of the optical waveguides is shorter after the trimming process than before the trimming process.

According to a further embodiment of the apparatus for trimming and splicing of the optical waveguides, the apparatus comprises a heating device for heating the second section of one of the optical waveguides. The control device is designed to control the heating device. The control device drives at least one of the holding device and the heating device such that the at least one of the holding device and the heating device is moved to a second position, at which the second section of one of the optical waveguides is heated by means of the heating device.

According to a further embodiment, the apparatus for trimming and splicing of the optical waveguides is designed such that one of the optical waveguides can be fixed at a third position of the holding device on the holding device. The control device drives the holding device such that the holding device is moved to the third position in order to fix one of the optical waveguides.

According to a further embodiment, the trimming device is arranged in the apparatus for trimming and splicing of the optical waveguides at a first distance from the third position. The control device can drive the holding device such that the holding device for trimming of one of the optical waveguides is moved from the third position through a distance which is shorter than the first distance. According to a further embodiment of the apparatus for trimming and splicing of the optical waveguides, the heating device of the apparatus for trimming and splicing of the optical waveguides is arranged at a second distance from the trimming device. The control device can drive the holding device such that the holding device is moved through the second distance from the first position in order to heat the second section of one of the optical waveguides.

With regard to the arrangement for trimming and splicing of optical waveguides, the object is achieved by an arrangement according to Claim 11. The arrangement comprises a holding device for holding one of the optical waveguides and a trimming device for trimming of one of the optical waveguides. The holding device can be moved to a first position at which one of the optical waveguides can be trimmed by means of the trimming device, wherein one of the optical waveguides is held in the holding device during the trimming process.

According to a further embodiment of the arrangement for trimming and splicing of the optical waveguides, the holding device is designed such that one of the optical waveguides can be fixed to the holding device in that a first section of the one of optical waveguides is held on the holding device and a second section, which is adjacent to the first section, projects out of the holding device. The trimming device is designed to trim one of the optical waveguides at a point on the second section of one of the optical waveguides such that the second section of one of the optical waveguides is shorter after the trimming process than before the trimming process.

According to a further embodiment of the arrangement for trimming and splicing of the optical waveguides, the holding device has a surface which has at least one raised area and recessed area. The trimming device has a surface which has at least one raised area and recessed area. The respective raised area and recessed area of the holding device and of the trimming device are matched to one another such that, when the surface of the holding device makes contact with the surface of the trimming device, an interlocking connection is formed between the holding device and the trimming device. A surface of the holding device and of the trimming device may be designed to be magnetic. The trimming device can be fixed on the holding device by means of a locking device. According to a further embodiment of the arrangement for trimming and splicing of the optical waveguides, the trimming device has a holding device for holding the second section of one of the optical waveguides. The trimming device may have a cutting device for trimming of one of the optical waveguides at the point of the second section of one of the optical waveguides. The cutting device can be designed such that the point of the second section of one of the optical waveguides may be varied by movement of the cutting device in the trimming device. The apparatus for trimming and splicing of the optical waveguides is designed such that the trimming device can be connected to the holding device in an interlocking manner when the holding device has been moved to the first position.

According to a further embodiment of the arrangement for trimming and splicing of the optical waveguides, the arrangement comprises a heating device for heating the second section of one of the optical waveguides. The holding device is designed such that it can be moved from the first position to a second position which is not the same as the first position. The heating device is arranged such that one of the optical waveguides is heated at the second position of the holding device.

According to a further embodiment of the arrangement for trimming and splicing of the optical waveguides, the holding device is arranged such that it can rotate about an axis. The holding device can be moved from the first position to the second position by rotation about the axis. The holding device may have a groove for insertion of one of the optical waveguides. The groove is arranged at right angles to the axis.

The arrangement may comprise a control device for controlling movement of the holding device and for controlling heating of one of the optical waveguides.

A method for trimming and splicing of optical waveguides is specified in the following text. According to the method, an apparatus for trimming and splicing of optical waveguides is provided, wherein the apparatus comprises a holding device for holding one of the optical waveguides, a trimming device for trimming of one of the optical waveguides, and a heating device for heating one of the optical waveguides. One of the optical waveguides is fixed on the holding device. At least one of the holding device and the trimming device is moved such that the at least one of the holding device and the trimming device is moved to a first position at which one of the optical waveguides can be trimmed by means of the trimming device. One of the optical waveguides is trimmed by means of the trimming device. At least one of the holding device and the heating device is moved to a second position, at which one of the optical waveguides can be heated by means of the heating device. One of the optical waveguides is heated by means of the heating device. One of the optical waveguides is spliced to a further one of the optical waveguides.

According to a further embodiment of the method, one of the optical waveguides is fixed such that a first section of one of the optical waveguides is held on the holding device and a second section, which is adjacent to the first section, of one of the optical waveguides projects out of the holding device. One of the optical waveguides is trimmed at a point on the second section, while one of the optical waveguides is fixed in the holding device.

According to a further embodiment, the holding device is moved to a third position in order to fix one of the optical waveguides on the holding device. According to one embodiment of the method, the apparatus for trimming and splicing of the optical waveguides can be provided, wherein the trimming device in the apparatus for splicing of the optical waveguides is arranged at a first distance from the third position. The holding device can be moved from the third position to the first position in order to trim one of the optical waveguides. According to a further embodiment of the method, the apparatus for trimming and splicing of the optical waveguides can be provided, wherein the heating device in the apparatus for trimming and splicing of the optical waveguides is arranged at a second distance from the trimming device. The holding device can be moved from the first position to the second position in order to heat one of the optical waveguides. The trimming device can be moved in order to trim one of the optical waveguides. The heating device can be moved in order to heat one of the optical waveguides.

According to a further embodiment of the method for trimming and splicing of optical waveguides, the apparatus is provided with a control device. The movement of the holding device and of the trimming device and of the heating device is controlled by means of the control device.

A further embodiment of a method for trimming and splicing of optical waveguides will be specified in the following text. According to the method, an apparatus for trimming and splicing of optical waveguides is provided with a holding device for holding one of the optical waveguides. One of the optical waveguides is fixed on the holding device. The holding device is moved to a first position at which one of the optical waveguides can be trimmed by means of the trimming device. A trimming device is arranged on the holding device. One of the optical waveguides is trimmed, wherein one of the optical waveguides is held in the holding device during the trimming process. The holding device is moved to a second position. One of the optical waveguides is heated in order to splice it to a further one of the optical waveguides.

According to a further embodiment of the method, one of the optical waveguides is fixed to the holding device in that a first section of one of the optical waveguides is held on the holding device and a second section, which is adjacent to the first section, projects out of the holding device. The trimming device can be arranged on the holding device such that an interlocking connection is formed between the trimming device and the holding device. The second section of one of the optical waveguides can be fixed on the trimming device. According to a further embodiment, the trimming device is provided with a cutting device. The cutting device can be moved in order to vary a point at which one of the optical waveguides is trimmed. According to a further embodiment of the method, the holding device can be moved from the first position to the second position by rotation of the holding device about an axis.

The concepts will be explained in more detail in the following text with reference to the figures, which show exemplary embodiments, and in which:

### BRIEF DESCRIPTION OF THE FIGURES

FIG. 1 shows one embodiment of an apparatus for trimming and splicing of optical waveguides having holding devices at a position for fixing the optical waveguides in the holding devices,

FIG. 2 shows an embodiment of an apparatus for trimming and splicing of optical waveguides having a holding device at a position for trimming of the optical waveguides,

FIG. 3 shows an embodiment of an apparatus for trimming and splicing of optical waveguides having a holding device at a position for splicing the optical waveguides and having a holding device at a position for trimming of the optical waveguides,

FIG. 4 shows an embodiment of an apparatus for trimming and splicing of optical waveguides having holding devices at a respective position for splicing of the optical waveguides,

FIG. 5 shows an embodiment of an arrangement for trimming and splicing of optical waveguides having holding devices at a position for fixing the optical waveguides in the holding devices,

FIG. 6 shows an embodiment of an arrangement for trimming and splicing of optical waveguides having a holding device at a position for trimming of a section of an optical waveguide,

FIG. 7 shows an embodiment of an arrangement for trimming and splicing of optical waveguides having a holding device at a position for trimming of a section of an optical waveguide,

FIG. 8A shows a first embodiment of a surface of a holding device and of a trimming device,

FIG. 8B shows a further embodiment of a surface of a holding device and of a trimming device, and

FIG. 9 shows an arrangement for trimming and splicing of optical waveguides having holding devices at a position for splicing of the optical waveguides.

### DETAILED DESCRIPTION OF THE PREFERRED EMBODIMENTS

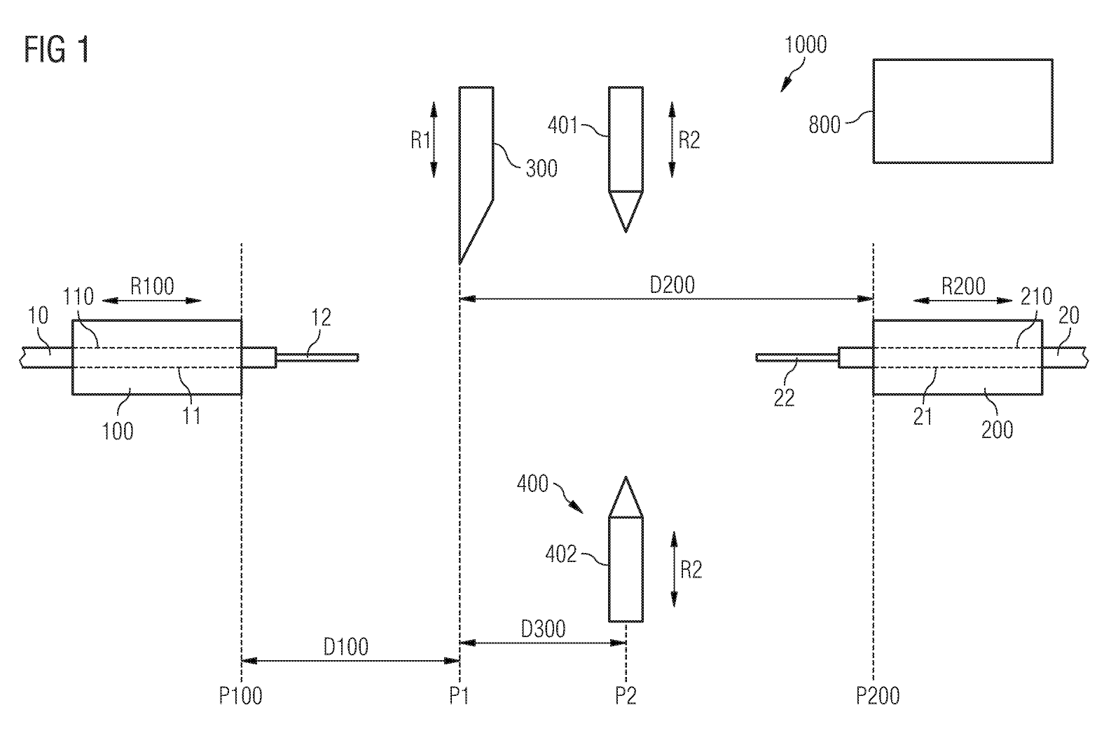

FIG. 1 shows an apparatus 1000 for trimming and splicing of optical waveguides. The apparatus comprises a holding device 100 for fixing an optical waveguide 10 and a holding device 200 for fixing an optical waveguide 20. The optical waveguides 10 and 20 are fixed to the holding devices 100 and 200 in such a way that sections 12 and 22 of the optical waveguides project out of the holding devices. Furthermore, the apparatus contains a trimming device 300. The sections 12, 22 of the optical waveguides 10, 20 are trimmed by means of the trimming device 300, in order to produce a straight break edge at the ends of the optical waveguides. The apparatus 1000 for splicing of the optical waveguides comprises a heating device 400 for heating of the respective end sections 12, 22 of the optical waveguides 10, 20 which project out of the holding devices.

The holding devices 100 and 200 can each be moved in a longitudinal direction R100 of the optical waveguides or in a longitudinal direction R100 of a groove 110 and 210, which is arranged in the holding devices, for insertion of the optical waveguides. The trimming device 300 is arranged at a position P1 and can be moved in a direction R1 at right angles to the longitudinal direction of the grooves 110, 210 or at right angles to the movement path of the holding devices 100, 200. The heating device 400 is arranged at a position P2. The heating device has electrodes 401 and 402 between which an arc is ignited in order to heat and to weld the optical waveguides 10 and 20. The electrodes 401 and 402 can be moved in a direction R2 parallel to the movement path of the trimming device 300 and at right angles to the movement path of the holding devices 100 and 200.

The trimming device 300 and the heating device 400 are arranged at a distance D300 from one another. In order to secure the optical waveguides 10 and 20 in the holding devices 100 and 200, the holding devices are moved to a respective position P100 or P200. The position P100 of the holding device 100 is at a distance D100 from the position P1 of the trimming device. The position P200 of the holding device 200 is at a distance D200 from the position P1.

Before the optical waveguides 10 and 20 are inserted into the holding devices 100, 200, a coating which surrounds the light-carrying core of the optical waveguides is pulled off the respective end of the optical waveguides to be spliced and the exposed fibre core is cleaned. The optical waveguide 10 is inserted into the holding device 100 in such a manner that a section 12 of the optical waveguide 10, from which the coating has been pulled off, projects out of the holding device 100. A section which is adjacent to the section 12 of the optical waveguide 10 and contains the light-carrying core of the optical waveguide and the coating is arranged in the groove 110 in the holding device 100.

The holding device 200 is moved to the position P200 in order to fix the optical waveguide 20 in the holding device 200. The optical waveguide 200 is fixed on the holding device 200 for example by insertion into a groove 210 in the holding device 200. That section 21 of the optical waveguide 20 which has been inserted into the groove 210 has a light-carrying core area and a coating. A section 22 of the optical waveguide 20 projects out of the holding device on one side. That section of the optical waveguide 20 which projects out of the holding device 20 has the light-carrying core area from which the coating has been removed.

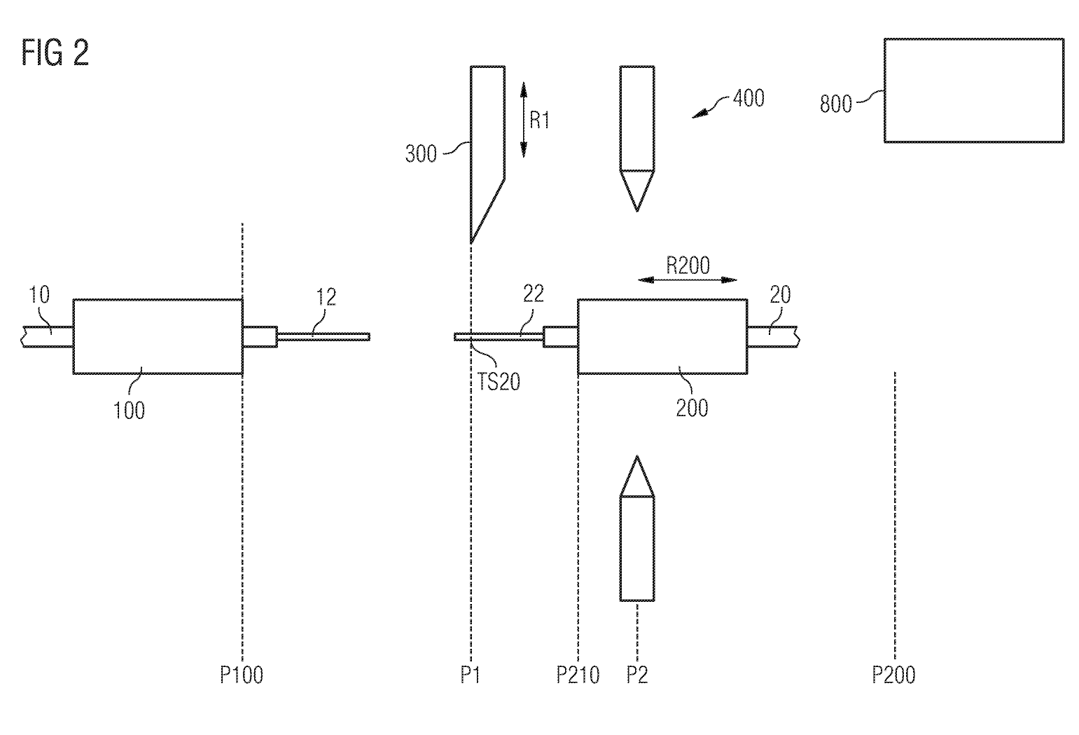

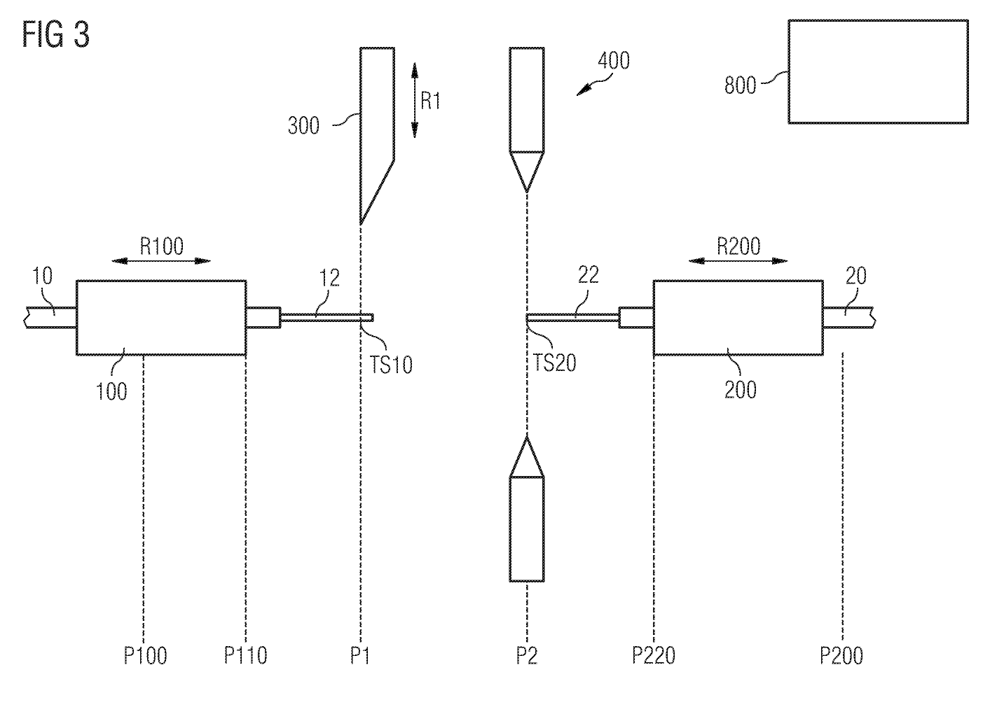

In order to trim those sections 12, 22 of the optical waveguides which project out of the holding devices, the holding devices 100 are moved to the position P110 and the holding device 200 is moved to the position P210. The positions P110 and P210 are shown in FIGS. 2 and 3. The movement of the holding devices 100 and 200 is controlled by a control device 800. FIG. 2 shows the holding device 200, which has been moved along the direction R200 from the position P200 to the position P210. The control device 800 controls the holding device 200 in such a manner that the holding device 200 is moved in the direction R200 through a distance which is shorter than the distance D200 between the positions P200 and P1. The holding device 200 is driven by the control device 800 such that the section 22 of the optical waveguide 20 is moved beyond the position P1 of the trimming device.

The control device 800 is likewise designed to control the trimming device 300. When the holding device has been moved to the positions P210, the trimming device 300 is activated. The trimming device 300 is moved in the direction R1 onto the section 22 of the optical waveguide 20 by being driven by a control signal which is produced by the control device 800. In order to carry out the trimming process, the trimming device 300 is driven by the control device such that the section 22 of the optical waveguide 20 is trimmed at a point TS20 by a cutting device of the trimming device. In this case, a straight break edge is produced at the trimming point TS20.

FIG. 3 shows the further movement of the holding devices 100 and 200. Since the distance D300 between the trimming device 300 and the heating device 400 is defined, the holding device 200 can be moved by the control device, after the trimming of the section 22 of the optical waveguide 20, in such a manner that the trimming point TS20 is located at the position P2. For this purpose, the holding device 200 is driven by a corresponding control signal from the control device 800 such that the front end of the control device 200 is moved to a position P220. The position P2 is located at or close to the arc path of the arc which is ignited between the electrodes of the heating device 400. The section 22 of the optical waveguide 20 can be heated by the heating device 400 at the position P2 when an arc is ignited between the electrodes of the heating device.

Once the holding device 200 has been moved in such a way that the trimming point TS20 of the optical waveguide 20 is located at the position P2, the holding device 100 is moved in the direction R100. The holding device 100 is for this purpose driven by the control device 800 such that the holding device 100 is moved so far that the section 12 of the optical waveguide 10 is moved beyond the position P1. The holding device 100 may, for example, be moved such that the front end of the holding device 100 is moved to the position P110. In order to trim the section 12 of the optical waveguide 10 at a point TS10, the trimming device 300 is activated by the control device 800. The trimming device 300 is for this purpose driven by the control device 800 by a control signal such that the trimming device is moved in a direction R1, in the direction of the section 12 of the optical waveguide. The control device then drives the trimming device in such a manner that a cutting device on the trimming device cuts the section 12 of the optical waveguide 10 at the point TS10, such that a straight break edge is created there.

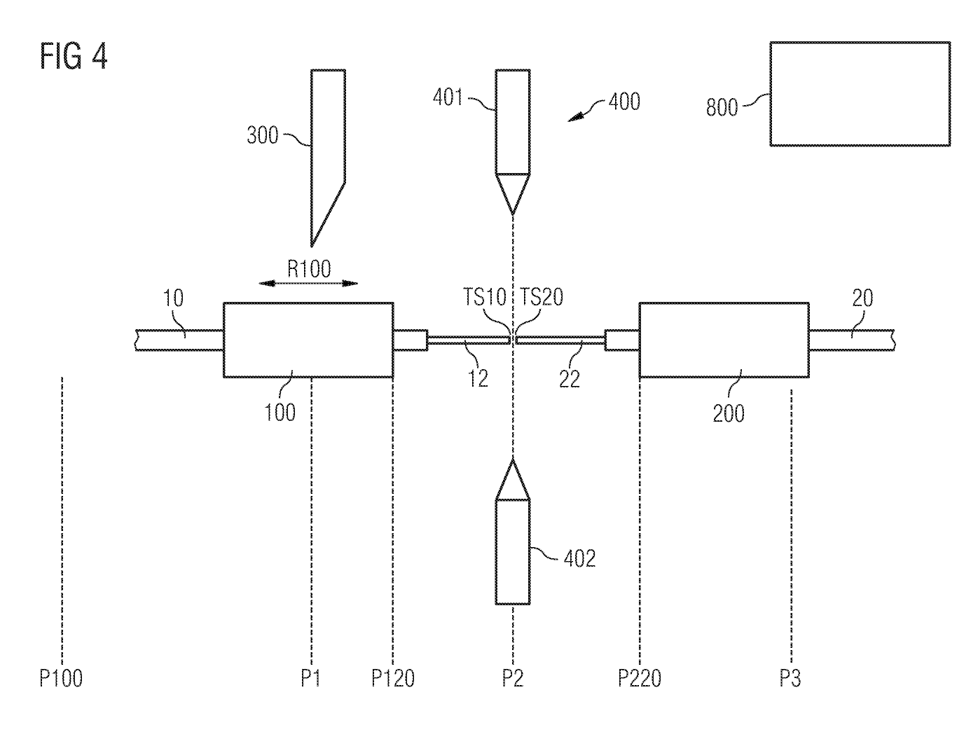

Since the distance D300 between the trimming device 300 and the heating device 400 is fixed by the arrangement of the trimming device and of the heating device in the splicing apparatus 1000, the holding device 100 is moved, after deactivation of the trimming device 300, in such a manner that the trimming point TS10 is moved to the position P2 at which the section 12 of the optical waveguide 10 can be heated by the heating device 400. The movement of the holding device 100 in the direction R100 is controlled by the control device 800 such that the holding device 100 is moved with its front end to a position P120. FIG. 4 shows the section 12 of the optical waveguide 10 and the section 22 of the optical waveguide 20, which are positioned at the position P2 for heating, after the movement of the holding devices 100 and 200.

Before an arc is ignited between the electrodes 401 and 402, the trimming device 300 can be driven by the control device 800 in such a manner that the trimming device is moved away in the direction R1 from the optical waveguides to be spliced. This makes it possible to ensure that the trimming device on the one hand does not influence the splicing process and on the other hand is not damaged by the heat of the arc. In order to heat the sections 11 and 12 of the optical waveguides 10 and 20, the heating device 400 is driven by the control device such that the electrodes 401 and 402 are moved in the direction R2 of the optical waveguides 10 and 20. The distance between the electrode tips can thus be reduced in order to ignite the arc. An arc is ignited between the electrodes by appropriately driving the heating device by the control device, in order to heat the sections 12 and 22 of the optical waveguides 10 and 20.

In the embodiment of the apparatus 1000 for trimming and splicing of optical waveguides as shown in FIGS. 1 to 4, the optical waveguides can be trimmed and the optical waveguides can be heated, with the optical waveguides each remaining fixed in the holding devices during and between the steps of trimming and heating. The holding devices can be moved between the positions at which the trimming process is carried out and the position at which the splicing process is carried out, with the movement of the holding devices being controlled by a control device.

The trimming device and the heating device are arranged at a defined distance with respect to the positions P100 and P200 of the holding devices. When the optical waveguides 10 and 20 have been fixed with a sufficient projection in the holding devices, the holding devices can be moved from the initial positions through a movement distance which is known in advance and which is less than the distances D100, D200 between the trimming device and the holding devices, in order to trim the sections 12 and 22 of the optical waveguides.

Since the trimming device 300 and the heating device 400 are likewise arranged at a defined distance from one another, the holding devices 100 and 200 are each moved through the distance D300 after the trimming of the sections 12 and 22 of the optical waveguides 10 and 20, which distance D300 corresponds to the distance D300 between the trimming device and the heating device. In consequence, the respective trimming points TS10 and TS20 of the optical waveguides can be positioned at a desired position with respect to the heating device.

Starting from the positions P100, P200, the holding devices can thus each be moved to at least positions P110, P120 and P210, P220 for trimming and for heating of the sections 12, 22 of the optical waveguides. The holding device 100 and 200 can be moved such that the trimming points of the optical waveguides are moved into the arc path, without any need to record the position of the trimming points TS10 and TS20 by means of complex optics. Appliance-specific tolerances of the trimming length, which indicates the distance between the trimming point of an optical waveguides and the holding device into which the optical waveguide is inserted, are avoided in the case of the embodiment of the apparatus 1000 for trimming and splicing of optical waveguides in which the trimming device is integrated in the apparatus 1000. Integration of the trimming device 300 in the apparatus 1000 allows automation of the entire trimming process and thus makes it possible to speed up the entire process, which comprises the trimming and the splicing of the optical waveguides. The trimming device, the heating device and the holding devices can be controlled by a single control device.

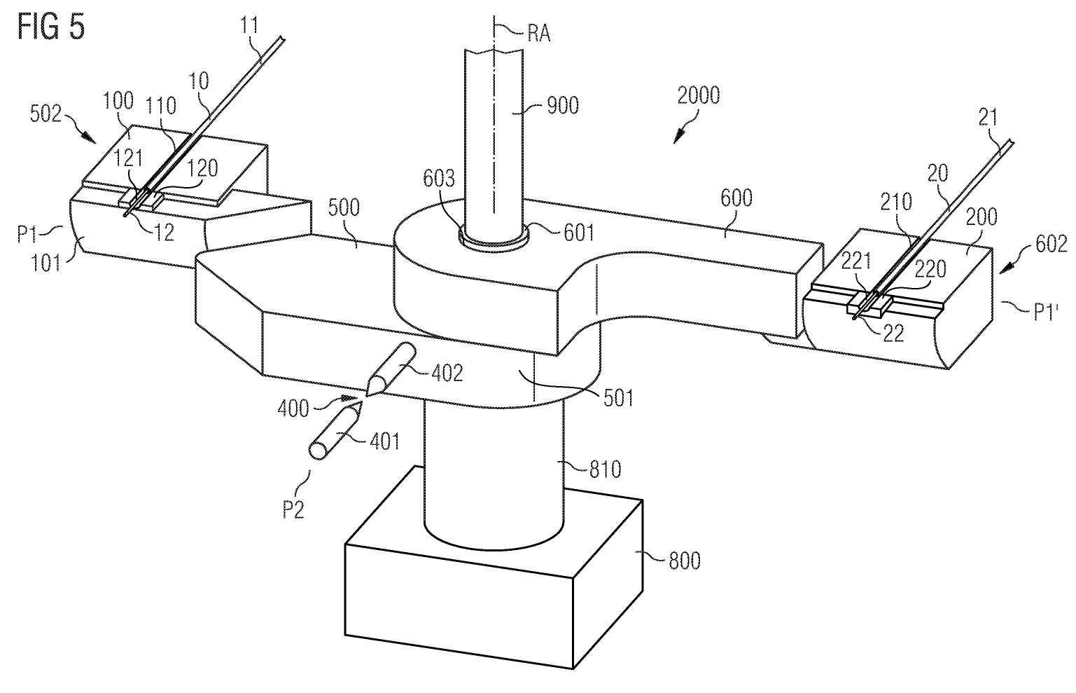

FIG. 5 shows an embodiment of an arrangement 2000 for trimming and splicing of optical waveguides. The arrangement comprises a holding device 100, which is arranged at one end of an arm 500. The arm 500 is arranged such that it can rotate about an axis RA on one side 501. For this purpose, the arm 500 and the side 501 are arranged on a holder 900 such that it can rotate, for example, by means of a ball bearing 503. The holding device 100 has a recessed area 110, for example a groove, into which the optical waveguide 10 can be inserted. The groove 110 is designed in such a manner that a section 11 of the optical waveguide 10, which contains a fibre core, surrounded by a coating, of the optical waveguide 10 can be inserted into the groove 110. An adjusting device 120, which has a recessed area 121, is arranged at one end of the recessed area 110. The recessed area 121 may be a grove which is aligned flush with the groove 110. The groove 121 is designed in such a manner that a section 12 of the optical waveguide 10, which contains the fibre core from which the coating has been removed, can be inserted into the groove 121. The grooves 110 and 121 are arranged at right angles to the axis RA about which the holding device 100 can rotate.

The arrangement 2000 for trimming and splicing of the optical waveguides furthermore comprises an arm 600, which is likewise arranged such that it can rotate about the axis RA. The arm 600 is for this purpose arranged on one side 601 on the holder 900 such that it can rotate, for example by means of a ball bearing 603. A holding device 200 is arranged on the arm 600, on a side 602 opposite the rotation axis RA. The holding device 200 comprises a recessed area 210, which, for example, may be in the form of a groove into which the optical waveguide 20 can be inserted. The recessed area 210 is in this case designed in such a manner that a section 21 of the optical waveguide 20, which comprises a fibre core surrounded by a coating, can be inserted into the groove. An adjusting device 220 is arranged on one side of the groove 210. The adjusting device 220 has a recessed area 221, which may likewise be in the form of a groove. The groove 221 is designed in such a manner that section 22 of the optical waveguide 20, which contains the fibre core from which the fibre coating has been removed, can be inserted into the groove 221. The grooves 221 and 210 run aligned with one another. Furthermore, the grooves 221 and 210 are aligned at right angles to the axis RA.

A heating device 400, which comprises electrodes 401 and 402, is provided in order to heat the ends of the optical waveguides to be spliced. The movement of the arms 500, 600 and the movement of the holding devices 100, 200 about the axis RA can be controlled by a control device 800. By way of example, a drive device 810 can be provided in order to move the arms 500, 600, and is driven with suitable control signals from the control device 800. The movement of the arms 500 and 600 can be controlled by the control device 800 such that the arm 500 is rotated about the axis RA in the direction of the position P2 starting from a position P1, and the arm 600 is moved by rotation about the axis RA to the position P2, starting from a position P1′. The section 12 of the optical waveguide 10 and the section 22 of the optical waveguide 20 can be heated by the heating device 400 at the position P2.

Before the splicing of the optical waveguides 10 and 20, the optical waveguides are prepared for a splicing process. For this purpose, the respective coating which surrounds the fibre core of the optical waveguides 10, 20 is pulled off on the section 12, 22 of the optical waveguides 10, 20. The sections 12, 22 of the optical waveguides 10, are then cleaned. In order to insert the optical waveguide 10 into the holding device 100, the arm 500 is moved in such a manner that the holding device 100 is moved to the position P1. At the position P1, the section 11 of the optical waveguide 10 is inserted into the recessed area 110 in the holding device 100. The front section 12 of the optical waveguide 10 is inserted into the recessed area 121 in the adjusting device 120. The holding device 100 is designed such that the optical waveguide 10 can be attached to the holding device 100 in such a manner that the section 12 projects out of the adjusting device 120. In order to fix the optical waveguide 10, a clamping device, which is not illustrated in FIG. 5, can be arranged above the recessed areas 110 and 121.

In order to insert the optical waveguide 20 into the holding device 200, the arm 600 is moved about the rotation axis RA, as a result of which the holding device 200 is moved to a position P1′. Before the optical waveguide 20 is attached to the holding device 200, a coating is pulled off the fibre core of the optical waveguide 20 on a front section 22 of the optical waveguide 20, and the exposed fibre core is cleaned. The section 21 of the optical waveguide 20 is inserted into the groove 210 in the holding device 200. The section 22 of the optical waveguide 20 is inserted into the recessed area 221 in the adjusting device 220. The optical waveguide 20 is fixed in the holding device 200 in such a manner that the section 22 of the optical waveguide 20 projects out of the adjusting device 220. A clamping device, which is not illustrated in FIG. 5, can be provided above the grooves 210 and 221 in order to fix the optical waveguide 20 in the recessed areas 210 and 221.

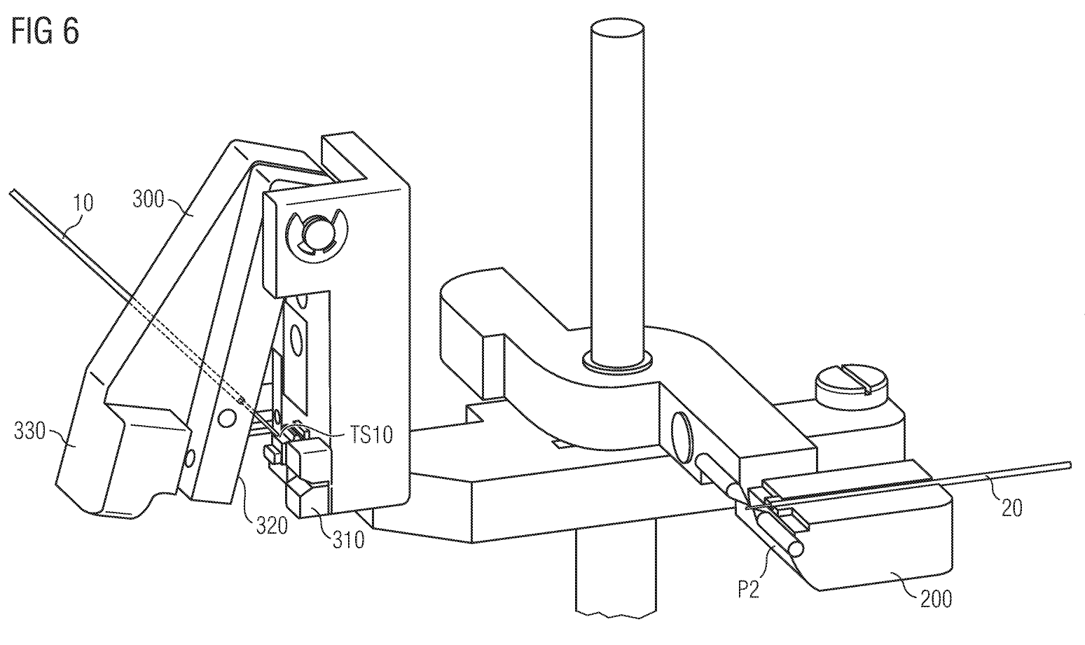

A trimming device 300 is used in order to produce a straight break edge on the section 12 of the optical waveguide 10. The arms 500 and 600 can be locked at the positions P1 and P1′, for example by means of a locking device which is not shown. FIG. 6 shows the arm 500 locked at the position P1. In order to trim the section 12 of the optical waveguide 10, the trimming device 300 is stopped on a surface 101 of the holding device 100. The surface of the holding device 100 and the surface of the trimming device on which the trimming device is held on the holding device are in this case designed in such a manner that an interlocking connection is created between the respective surfaces of the holding device and of the trimming device. In order to ensure that the trimming device does not slide on the surface of the holding device during the trimming of the section 12 of the optical waveguide 10, but is fixed securely onto the surface, the surfaces of the holding device and of the trimming device may also, for example, be designed to be magnetic.

The trimming device 300 comprises a holding device 310 and a cutting device 320. The holding device 310 is designed such that a front part of the section 12 of the optical waveguide 10 is clamped in the holding device 310 of the trimming device 300. The cutting device 320 is activated in order to trim the section 11 of the optical waveguide 10. By way of example, the cutting process can be activated by pushing an activation device 330 down manually. The activation device may be in the form of a lever on the trimming device, by means of which the cutting device is pushed down. The trimming process results in a straight break edge at a point TS10 on the section 12 of the optical waveguide 10.

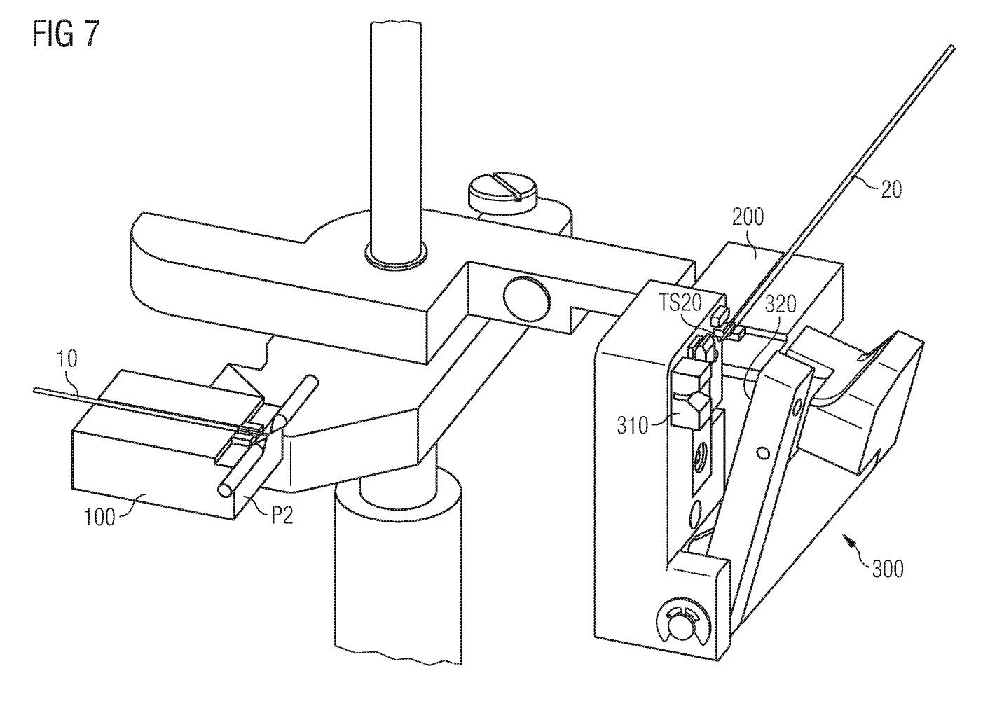

FIG. 7 shows the trimming of the optical waveguide 20 by means of the trimming device 300. The arm 600 is locked at the position P1′ in order to fit the trimming device 300 to the holding device 200. The surfaces of the holding device 200 and of the trimming device 300 which the trimming device and the holding device touch when the trimming device is held on the holding device 200 are designed in such a manner that an interlocking connection is produced between the holding device 200 and the trimming device 300. That section 22 of the optical waveguide 20 which projects out of the holding device 200 is inserted into the trimming device 300. A front part of the section 22 of the optical waveguide 20 is fixed on the trimming device 200 by means of the holding device 310 of the trimming device.

The cutting device 320 is activated by pushing the activation device 330 down, in order to trim the section 22 of the optical waveguide 20. The section 22 of the optical waveguide 20 is thus trimmed at a point TS20 in a manner which results in a straight break edge.

The trimming length indicates the length of the sections 12 and 22 of the optical waveguides which project out of the holding devices. Since the trimming device 300 can be held in an interlocking manner on the surface of the holding device 100 or on the surface of the holding device 200, the sections 12 and 22 of the optical waveguides 10 and 20 are respectively trimmed at the points TS10 and TS20, which are at a specific distance from the end of the adjusting devices 120 and 220 of the holding devices. The optical waveguides 10 and 20 can therefore be trimmed with a defined trimming length with respect to the holding devices. The cutting device 320 can be arranged such that it can be moved in the trimming device 300. This makes it possible to vary the trimming length.

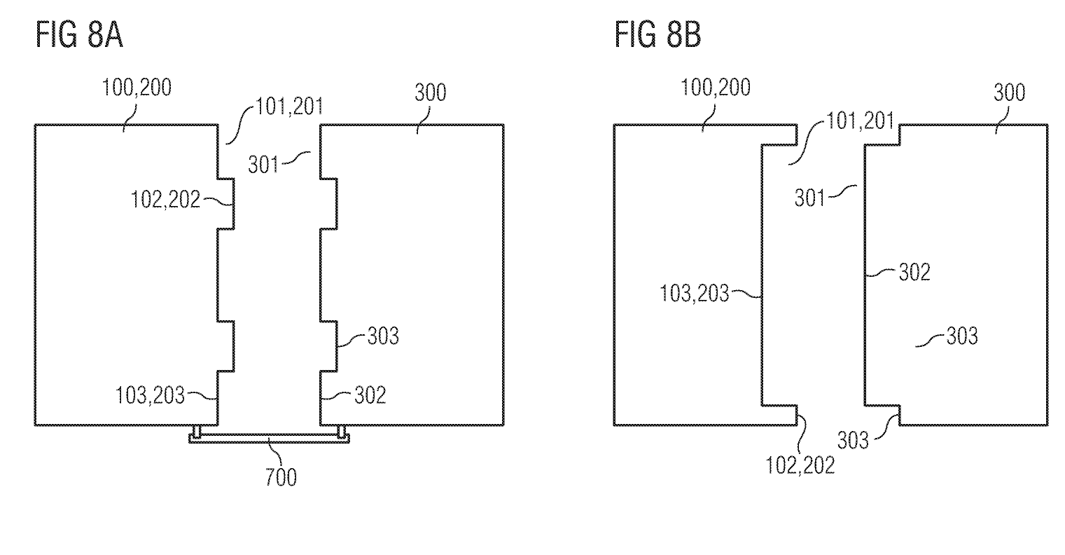

FIG. 8A shows one embodiment of the surface 101, 201 of the holding devices 100, 200, and a surface 301 of the trimming device 300, which surfaces allow an interlocking connection of the holding devices and of the trimming device. The surfaces 101, 201 of the holding devices 100, 200 may have raised areas 102, 202 and recessed areas 103, 203. The surface 301 of the trimming device 300 has raised areas 302 and recessed areas 303 which are arranged opposite the raised areas and recessed areas on the surfaces 101, 201 of the holding devices 100, 200. When the surface 301 of the trimming device 300 is held on the surfaces of the holding devices 100, 200, this results in an interlocking connection which prevents the trimming device from being moved with respect to the holding devices, in the horizontal direction with respect to the respective surfaces 101, 201 of the holding devices, during the trimming process.

FIG. 8B shows a further embodiment of the surfaces 101, 201 of the holding devices 100, 200 and of the surface 301 of the trimming device 300. The surfaces 101, 201 of the holding devices 100, 200 may have raised areas 102, 202 at their edges. The trimming device 300 has a corresponding recessed area 303, arranged symmetrically with respect thereto, on one edge of the surface 301. A recessed area 103, 203 is provided between the edge-side raised areas 102, 202 of the holding devices. In a corresponding manner, the surface 301 of the trimming device 300 has a raised area 302 which is arranged symmetrically with respect thereto. When the trimming device and the holding devices are joined together, this therefore results in an interlocking connection, which prevents the trimming device from being moved horizontally with respect to the surfaces 101, 201 and 301.

In the case of the embodiments of the trimming and holding devices shown in FIGS. 8A and 8B, the respective surfaces of the holding devices and of the trimming device may be designed to be magnetic, in order to improve the coupling between the holding devices and the trimming device. Furthermore, a locking device 700 can be provided on the holding devices and on the trimming device. The magnetic coupling between the holding devices and the trimming device and the locking make it possible to prevent the trimming device from sliding or moving on the surfaces of the holding devices 100, 200 during the trimming process.

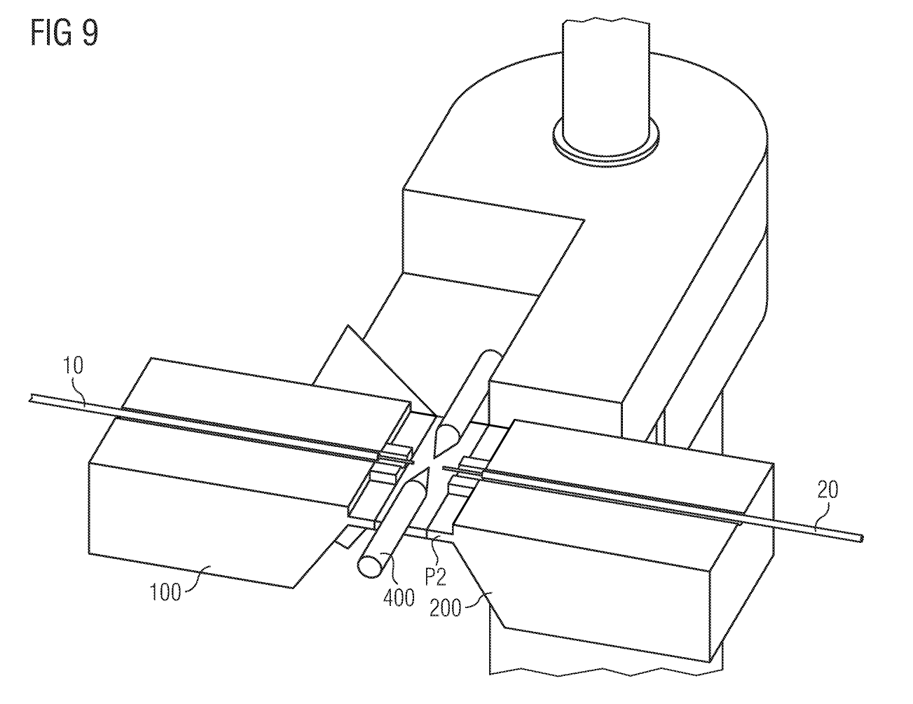

Once the optical waveguides 10 and 20 have been trimmed with a specific trimming length by the trimming device 300, the arms 500 and 600 can be moved from the respective positions P1 and P1′ to the position P2. The control device 800 drives the drive device 810 by means of suitable control signals in order to move the arms 500, 600. FIG. 9 shows the holding devices 100, 200, which have been moved from the positions P1, P1′ to the position P2 as a result of movement of the arms 500, 600. At the position P2, the trimmed end surfaces of the optical waveguides 10 and 20 are opposite one another and can be heated by the heating unit 400.

In the embodiments of the arrangement for trimming and splicing of optical waveguides shown in FIGS. 5 to 9, the optical waveguides can remain inserted in the holding devices during the trimming process and the splicing process. The holding devices are moved, controlled by a control device, to a position for trimming and to a position for splicing. Since the optical waveguides need no longer be removed from a holding device and need no longer be inserted into the holding device again for trimming and for splicing, the trimming and the splicing processes are simplified.

At the positions P1 and P1′, the holding devices 100 and 200 are so far away from the heating device 400 that the trimming device 300 can be held on a respective surface of the holding devices. The trimming device and the holding devices are designed in such a manner that an interlocking connection is produced when the trimming device is held on the holding device. This results in a precise insertion position for the fibre end surface. Furthermore, the sections 12 and 22 of the optical waveguides 10 and 20, respectively, can be trimmed with a short projection, by means of which they project beyond the holding devices. Short splice lengths can be achieved using the arrangement 2000, for small splicing cassettes and high packing densities. There is no need to use fibre adapters, which must be pushed into an external trimming device and then positioned on a holding device in a splicer.

We claim:

1. Apparatus for trimming and splicing of optical waveguides, comprising:
a holding device for holding one of the optical waveguides;
a trimming device for trimming of one of the optical waveguides;
a control device for controlling a movement of at least one of the holding device and the trimming device and for controlling the trimming of one of the optical waveguides; and
wherein the control device drives at least one of the holding device and the trimming device such that the at least one of the holding device and the trimming device is moved to a first position at which one of the optical waveguides is positioned to be trimmed by means of the trimming device.

2. The apparatus according to claim 1, wherein the control device drives the trimming device in order to trim one of the optical waveguides.

3. The apparatus according to claim 1, wherein the holding device is designed such that one of the optical waveguides is fixable to the holding device in that a first section of one of the optical waveguides is held on the holding device and a second section, which is adjacent to the first section, projects out of the holding device, and the trimming device is designed to trim one of the optical waveguides at a point on the second section, while the one of optical waveguides is fixed in the holding device.

4. The apparatus according to claim 3, wherein the trimming device is designed to trim one of the optical waveguides at the point such that the second section of one of the optical waveguides is shorter after the trimming process than before the trimming process.

5. The apparatus according to claim 1, further comprising:
a heating device for heating the second section of one of the optical waveguides, wherein the control device is designed to control the heating device, and the control device drives at least one of the holding device and the heating device such that the at least one of the holding device and the heating device is moved to a second position, at which the second section of one of the optical waveguides is heated by means of the heating device.

6. The apparatus according to claim 5, wherein the apparatus for trimming and splicing of the optical waveguides is designed such that one of the optical waveguides is fixable at a third position of the holding device on the holding device, wherein the control device drives the holding device such that the holding device is moved to the third position in order to fix one of the optical waveguides.

7. The apparatus according to claim 6, wherein the trimming device is arranged in the apparatus for trimming and splicing of the optical waveguides at a first distance from the third position.

8. The apparatus according to claim 7, wherein the control device drives the holding device such that the holding device for trimming of one of the optical waveguides is moved from the third position through a distance which is shorter than the first distance.

9. The apparatus according to claim 5, wherein the heating device is arranged in the apparatus for trimming and splicing of the optical waveguides at a second distance from the trimming device.

10. The apparatus according to claim 9, wherein the control device drives the holding device such that the holding device is moved through the second distance from the first position in order to heat the second section of one of the optical waveguides.

11. An arrangement for trimming and splicing of optical waveguides, comprising:
a holding device for holding one of the optical waveguides;
a trimming device for trimming of one of the optical waveguides; and
wherein the holding device is movable to a first position at which one of the optical waveguides is trimmable by means of the trimming device, wherein one of the optical waveguides is held in the holding device during the trimming process.

12. The arrangement according to claim 11, wherein the holding device is designed such that one of the optical waveguides is fixable to holding device in that a first section of one of the optical waveguides is held on the holding device and a second section, which is adjacent to the first section, projects out of the holding device; and
wherein the trimming device is designed to trim one of the optical waveguides at a point on the second section of one of the optical waveguides such that the second section of one of the optical waveguides is shorter after the trimming process than before the trimming process.

13. The arrangement according to claim 11, wherein the holding device has a surface which has at least one raised area and recessed area, wherein the separation device has a surface which has at least one raised area and recessed area, wherein the respective raised area and recessed area of the holding device and of the trimming device are matched to one another such that, when the surface of the holding device makes contact with the surface of the trimming device, an interlocking connection is formed between the holding device and the trimming device.

14. The arrangement according to claim 11, wherein at least one surface of the holding device and of the trimming device is magnetic.

15. The arrangement according to claim 11, wherein the trimming device is fixable on the holding device by means of a locking device.

16. The arrangement according to claim 11, wherein the trimming device has a holding device for holding the second section of one of the optical waveguides.

17. The arrangement according to claim 12, wherein the trimming device has a cutting device for trimming of one of the optical waveguides at the point of the second section of one of the optical waveguides.

18. The arrangement according to claim 17, wherein the cutting device is designed such that the point of the second section of one of the optical waveguides is varied by movement of the cutting device in the trimming device.

19. The arrangement according to claim 11, wherein the apparatus for trimming and splicing of the optical waveguides is designed such that the trimming device is connectable to the holding device in an interlocking manner when the holding device has been moved to the first position.

20. The arrangement according to claim 11, further comprising:
a heating device for heating the second section of one of the optical waveguides;
wherein the holding device is designed movable from the first position to a second position which is not the same as the first position and the heating device is arranged such that one of the optical waveguides is heated at the second position of the holding device.

21. The arrangement according to claim 20, wherein the holding device is arranged to be rotatable about an axis, wherein the holding device is moved from the first position to the second position by rotation about the axis.

22. The arrangement according to claim 21, wherein the holding device has a groove for insertion of one of the optical waveguides and the groove is arranged at right angles to the axis.

23. The arrangement according to claim 20, further comprising:
a control device for controlling movement of the holding device and for controlling heating of one of the optical waveguides.
